(19) United States
(12) Patent Application Publication
(10) Pub. No.: US 2023/0412424 A1
(43) Pub. Date: Dec. 21, 2023

(54) System and Method for Virtual Local Area Network (VLAN) Assignment

(71) Applicant: 5321 Innovation Labs LLC, Franklin, MA (US)

(72) Inventors: Edward W. Neipris, Wrentham, MA (US); Gaurav Jain, Moorpark, CA (US); Tyler Nesper, Denver, CO (US)

(21) Appl. No.: 18/338,226

(22) Filed: Jun. 20, 2023

Related U.S. Application Data
(60) Provisional application No. 63/366,742, filed on Jun. 21, 2022.

(51) Int. Cl. H04L 12/46

(52) U.S. Cl. CPC H04L 12/4679

(57) ABSTRACT

A system and corresponding computer-implemented method perform virtual local area network (VLAN) assignment. The method identifies, automatically, whether a network-enabled device is associated with a previously assigned VLAN for a network. The network-enabled device has passed authentication. The authentication is responsive to a request sent from the network-enabled device to network equipment for access to the network. Based on a result of the identifying, the method automatically (i) selects a VLAN from a pool of dynamically assignable VLANs, (ii) associates the VLAN selected with the network-enabled device, and (iii) instructs the network equipment to assign the network-enabled device to the VLAN selected from the pool.

### RELATED APPLICATION

This application claims the benefit of U.S. Provisional Application No. 63/366,742, filed on Jun. 21, 2022. The entire teachings of the above application are incorporated herein by reference.

### BACKGROUND

A Local Area Network (LAN) interconnects network-enabled devices, such as laptops, printers, tablets, or servers, within a limited geographic area, such as a school, office building, residence, or campus. As more network-enabled devices connect to a LAN, it becomes beneficial to separate this LAN into more manageable and policy driven segments. A Virtual Local Area Network (VLAN) provides this segmentation. By segmenting network-enabled devices together by function or requirements, specific policies can be defined to help with service levels, security, and congestion. For example, a network-enabled device that should be allowed access to an accounting server should be placed on an Accounting VLAN; a network-enabled device on a different VLAN, such as a Development VLAN, would have policies applied that would not allow it to access the same accounting server.

There are several well-known processes of assigning network-enabled devices to the appropriate VLAN. Some of these processes involve matching a user, device type, or required function to a known VLAN. In all instances of these processes, the VLAN assignment is predefined, and rules are implemented to match the network-enabled device to the predefined VLAN. For instance, within an office building, there could be three defined VLANs, each with its own function, such as a Voice-Over-IP (VOIP) VLAN, a Production VLAN, and a Guest VLAN.

If a VOIP telephone connects to such a network, a request could be sent to an authentication server. This authentication server could identify the device as a VOIP telephone by a media access (MAC) address or device profile. The authentication server could instruct the connecting network equipment (e.g., network switch, access point, etc.) to place the VOIP telephone into the VOIP VLAN. When a different class of network-enabled device, such as an employee laptop, connects to the same connecting network equipment, a similar request could be sent to an authentication server. The authentication server may ask for additional credentials, such as a username or password. Once the authentication server has validated the credentials, it could instruct the connecting network equipment to place this network-enabled device into the Production VLAN. And lastly, if yet a third class of network-enabled device were to connect to the same connecting network equipment, a request could be sent to an authentication server. In this instance, if the authentication server is unable to identify the device class, device type, or device user, it could instruct the connecting network equipment to place the network-enabled device into the Guest VLAN.

### SUMMARY

According to an example embodiment, a computer-implemented method for virtual local area network (VLAN) assignment comprises identifying, automatically, whether a network-enabled device is associated with a previously assigned VLAN for a network. The network-enabled device has passed authentication. The authentication is responsive to a request sent from the network-enabled device to network equipment for access to the network. The computer-implemented method further comprises, based on a result of the identifying, automatically (i) selecting a VLAN from a pool of dynamically assignable VLANs, (ii) associating the VLAN selected with the network-enabled device, and (iii) instructing the network equipment to assign the network-enabled device to the VLAN selected from the pool.

According to an example embodiment, (i), (ii), and (iii) may be performed, automatically, based on the result indicating that there is no previously assigned VLAN associated with the network-enabled device. In an event the result indicates that the network-enabled device is associated with the previously assigned VLAN, the computer-implemented method may further comprise instructing the network equipment to assign the network-enabled device to the previously assigned VLAN.

According to an example embodiment, (i), (ii), and (iii) may be performed, automatically, based on the result indicating that a) there is no previously assigned VLAN associated with the network-enabled device and b) the network-enabled device is not associated with another network-enabled device that has received a respective VLAN assignment.

In an event the result indicates that there is no previously assigned VLAN associated with the network-enabled device and that the network-enabled device is associated with a different network-enabled device that is associated with a respective VLAN from the pool, the computer implemented method may not perform (i), (ii), and (iii) and may further comprise associating the network-enabled device with the respective VLAN associated with the different network-enabled device and instructing the network equipment to assign the network-enabled device to the respective VLAN.

The pool of dynamically assignable VLANs may be stored in a database. The identifying may include retrieving data from the database and identifying whether the network-enabled device is associated with the previously assigned VLAN based on the data retrieved.

The computer-implemented method may further comprise maintaining the pool of dynamically assignable VLANs based on at least one timer and refreshing a timer of the at least one timer based on receipt of a refresh signal. The timer may be associated with the VLAN selected. The computer-implemented method may further comprise, in response to a timeout of the timer, dissociating the VLAN selected from the network-enabled device and all other network-enabled devices associated with the VLAN selected. The dissociating may cause the VLAN selected to be returned to the pool as an unused VLAN. The timeout may be due to lack of receipt of the refresh signal. The computer-implemented method may further comprise, in response to the dissociating, instructing the network equipment to de-assign the network-enabled device from the VLAN selected.

The selecting may include ensuring that the VLAN selected from the pool of dynamically assignable VLANs is not associated with another network-device that is not associated with the network device. The selecting may further include ensuring that the VLAN selected is not in a lockout period.

The computer-implemented method may further comprise associating the VLAN selected with the network-enabled device and a credential of a user of the network-enabled device.

The computer-implemented method may further comprise associating the VLAN selected with a media access control (MAC) address of the network-enabled device, embedded identity document (EID) corresponding to an embedded subscriber identity module (eSIM) of the network-enabled device, or other unique identifier of the network-enabled device.

According to another example embodiment, a system for virtual local area network (VLAN) assignment comprises at least one processor and at least one memory. The at least one memory has encoded thereon a sequence of instructions which, when loaded and executed by the at least one processor, causes the at least one processor to identify, automatically, whether a network-enabled device is associated with a previously assigned VLAN for a network. The network-enabled device has passed authentication. The authentication is responsive to a request sent from the network-enabled device to network equipment for access to the network. Based on a result of the identifying, the sequence of instructions further causes the processor to automatically (i) select a VLAN from a pool of dynamically assignable VLANs, (ii) associate the VLAN selected with the network-enabled device, and (iii) instruct the network equipment to assign the network-enabled device to the VLAN selected from the pool.

The system may be a cloud-based system.

Alternative system embodiments parallel those described above in connection with the example computer-implemented method embodiment.

A non-transitory computer-readable medium for virtual local area network (VLAN) assignment has encoded thereon a sequence of instructions which, when loaded and executed by at least one processor, causes the at least one processor to identify, automatically, whether a network-enabled device is associated with a previously assigned VLAN for a network. The network-enabled device has passed authentication. The authentication is responsive to a request sent from the network-enabled device to network equipment for access to the network. Based on a result of the identifying, the sequence of instructions further causes the processor to automatically (i) select a VLAN from a pool of dynamically assignable VLANs, (ii) associate the VLAN selected with the network-enabled device, and (iii) instruct the network equipment to assign the network-enabled device to the VLAN selected from the pool.

Alternative non-transitory computer-readable medium embodiments parallel those described above in connection with the example computer-implemented method embodiment.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an example embodiment of a computing environment.

FIG. 2 is a flow diagram of an example embodiment of a dynamic virtual local area network (VLAN) configuration process (DVCP) workflow.

FIGS. 3A-D are flow diagrams of example embodiments of methods for DVCP maintenance.

FIG. 4 is a flow diagram of an example embodiment of a computer-implemented method for VLAN assignment.

FIG. 5 is a block diagram of an example internal structure of a computer optionally within an embodiment disclosed herein.

### DETAILED DESCRIPTION

A description of example embodiments follows.

Conventional processes provide a means to associate known and unknown network-enabled devices to a static, known, predefined, currently used, and pre-policied VLAN. A known device is one in which an authentication server is able to identify the device as previously registered and a VLAN assignment is pre-existing, while an unknown device is one in which the authentication server has no knowledge of the device and would generally place this device in a “guest” VLAN, such as the Guest VLAN described above. There are times that assigning network-enabled devices to dynamic, unknown, undefined, currently unused and/or un-policied VLANs are beneficial. For instance, perhaps the guest VLAN had a network policy applied that restricted access from any network-enabled device on this VLAN only to communicate with the Internet. If a network-enabled device were to be placed within this VLAN, this device would not have access to communicate with any other device within the VLAN. If this network-enabled device had a need to communicate with a second network-enabled device within this VLAN, such as a laptop connecting to a network-enabled display screen, each of these devices would need to join a VLAN that allows communication between the two. The administrator of the network would need to create a new VLAN, apply policy to the new VLAN, inform the authentication server of the new VLAN, and associate the new VLAN to the network-enabled devices that need to communicate in the authentication server.

Described herein is a unique method to allow for a known or unknown device to be assigned to a currently unused VLAN, automatically, and enable functionality by way of network policy.

### Unique Process to Assign Network-Enabled Devices to a Currently Unused VLAN

An example embodiment of a process to assign a network-enabled device to a currently unused VLAN utilizes standards-based network communications protocols and common data storage techniques. This process provides a mechanism to assign a network-enabled device to a VLAN where:
1) a VLAN is predefined for the device;
2) a VLAN is not predefined for the device;
3) a VLAN is not predefined for the device, but the device is associated with another network-enabled device that has received a VLAN assignment.

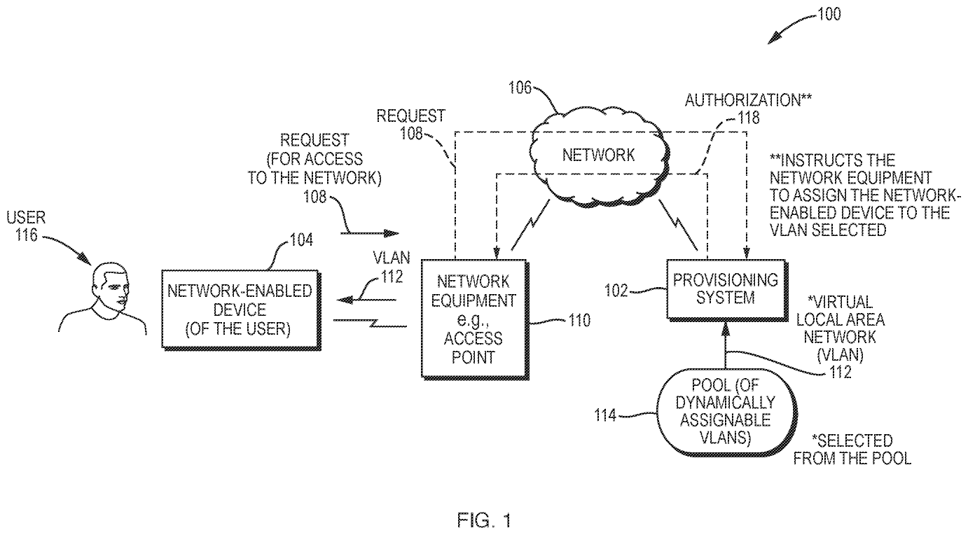

According to an example embodiment. a provisioning system may be configured to perform such a process and to provide a mechanism to define a list or range of VLANs that may be considered dynamically assignable by the process. The process may be interchangeably referred to herein as a dynamic VLAN process or dynamic VLAN configuration process (DVCP). The provisioning system may also be configured to define a default VLAN should there be no available dynamic VLANs. The provisioning system may also be configured to employ a set of maintenance routines to determine if a dynamically assignable VLAN is currently in use and not available to assign to a newly authenticated network-enabled device. An example embodiment of such a provisioning system is disclosed below with regard to FIG. 1.

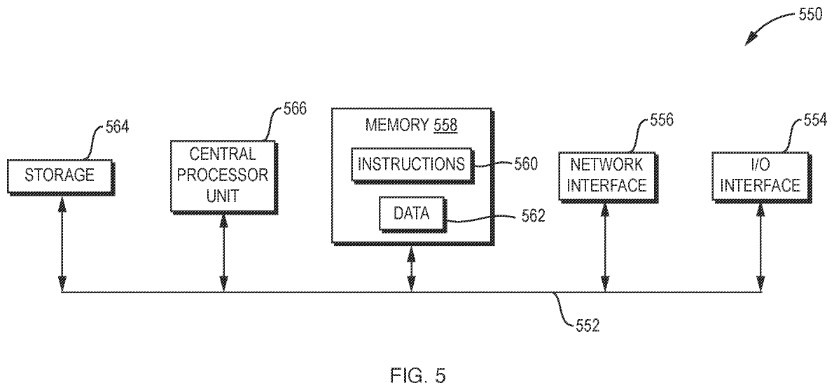

FIG. 1 is a block diagram of an example embodiment of a computing environment 100. The computing environment 100 includes a provisioning system 102 configured to perform VLAN assignment. The provisioning system 102 may be referred to, simply, as a system herein. The provisioning system 102 includes at least one processor (not shown) and at least one memory (not shown), such as the central processor unit 566 and memory 558 of FIG. 5, respectively, disclosed further below for non-limiting example.

Continuing with FIG. 1, the at least one memory has encoded thereon a sequence of instructions (not shown) which, when loaded and executed by the at least one processor, causes the at least one processor to identify, automatically, whether a network-enabled device 104 is associated with a previously assigned VLAN (not shown) for a network 106. The network-enabled device 104 has passed authentication. The authentication is responsive to a request 108 sent from the network-enabled device 104 to network equipment 110 for access to the network 106. Based on a result of the identifying, the sequence of instructions further causes the at least on processor to automatically (i) select a VLAN 112 from a pool 114 of dynamically assignable VLANs, (ii) associate the VLAN 112 selected with the network-enabled device 104, and (iii) instruct the network equipment 110 to assign the network-enabled device 110 to the VLAN 112 selected from the pool 114.

The network-enabled device 104 may be a wireless device, the network 106 may be a wireless network, and the network equipment 110 may be an access point (AP), for non-limiting examples. The network-enabled device 104 may have a user interface (not shown) that is accessible to a user 116 of the network-enabled device 104. Alternatively, the network-enabled device 104 may not have a user interface. The network-enabled device 104 may be a smartphone, tablet computer, laptop computer, desktop computer, printer, Internet-of-Things (IoT) device, or other network-enabled device of the user 116 for non-limiting examples. The provisioning system 102 may be a cloud-based provisioning system for non-limiting example.

When the network-enabled device 104 requests access to the network 106, it may go through at least one authentication process to validate that the network-enabled device 106 is allowed to access the network 108. The at least one authentication process may be performed by the provisioning system 102 or another computer-based system. For non-limiting example, the at least one authentication process may perform authentication of the network-enabled device 104, such as disclosed in U.S. Pat. No. 11,317,285, filed on Sep. 30, 2020, entitled “Wireless Network Provisioning Using a Pre-Shared Key,” the entire teachings of which are incorporated herein by reference, or via another authentication process known in the art for non-limiting examples.

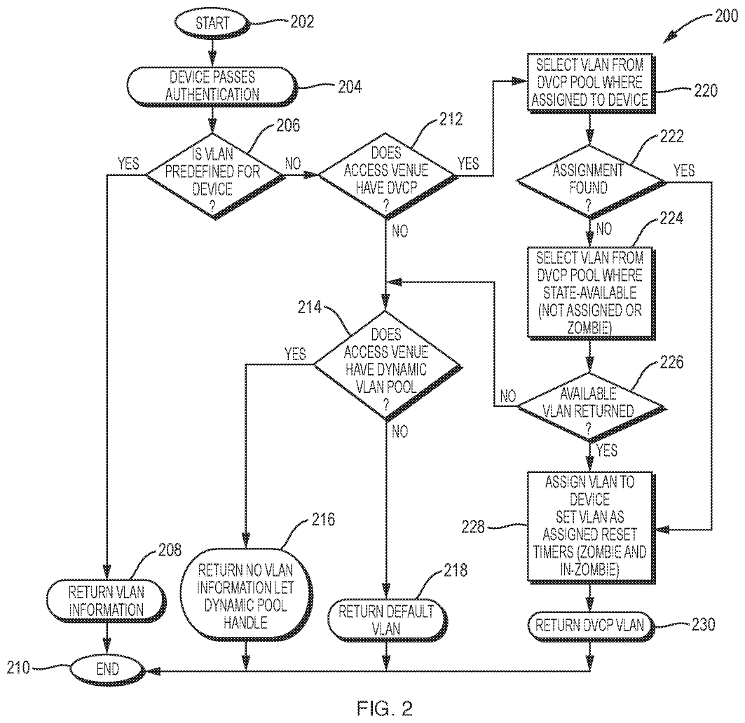

The network equipment 110 may be configured to forward the request 108 via the network 106 to the provisioning system 102. Once the network-enabled device 104 passes authentication, the provisioning system 102 may employ an example embodiment of a dynamic VLAN configuration process (DVCP) that may be engaged to provide authorization 118 to the network-enabled device 104 via the network equipment 110. This authorization 118 may include and return a VLAN identifier, such as the VLAN 112, to the network equipment 110 from which the network-enabled device 104 is requesting access. The authorization 118 may include other pieces of information or instructions to the network equipment 110 to control the flow of data to or from the network-enabled device 104. These other pieces of information or instructions may include, but are not limited to, bandwidth restrictions, access time restrictions, source-destination filtering, or any other standard network policy that may be typically applied to a network, such as the network 106. As disclosed above, an example embodiment of a DVCP process may be performed by the provisioning system 102. Example embodiments with regard to such a process are disclosed below with regard to FIG. 2.

### Dynamic VLAN Configuration Process (DVCP)

FIG. 2 is a flow diagram of an example embodiment of a dynamic VLAN configuration process (DVCP) 200 workflow. With reference to FIG. 1 and FIG. 2, the DVCP process 200 may begin (202) and, after the network-enabled device 104 passes authentication (204), check for whether a VLAN is predefined for the network-enabled device (204), that is, the network-enabled device 104. Passing authentication could be based on a unique device identifier, a username, a password, or a combination of all for non-limiting examples. To check for whether a VLAN is predefined for the network-enabled device (204), the provisioning system 102 may be configured to check a set of rules stored in a database (not shown), utilizing common data storage and retrieval techniques, to identify if there is a VLAN predefined for the network-enabled device 104. Such a predefined VLAN may be referred to interchangeably herein as a previously assigned VLAN. If there is a VLAN predefined for the network-enabled device 104, the provisioning system 102 may be configured to instruct the network equipment 110, from which the network-enabled device 104 is requesting access, to assign the network-enabled device 104 to the predefined VLAN by return the VLAN information (208). The provisioning system 102 may be further configured to instruct the network equipment 110 to apply any restrictions or policies defined for the network-enabled device 104. Such restrictions or policies may be stored in the database for non-limiting example. The process workflow thereafter ends (210) in the example embodiment.

If, however, there is no VLAN predefined for the network-enabled device 104, the process workflow may include checking for whether an access venue, such as the network 106, supports DVCP (212). For example, the provisioning system 102 may be configured to perform a check to identify if the current network, that is, the network 106, provides support for DVCP. If the network does not support DVCP, the provisioning system 102 may be configured to check to see if the current network, that is, the network 106, supports a dynamic VLAN pool system (214), which is a common VLAN assignment system designed to balance the number of devices connected to a VLAN. The dynamic VLAN pool system may be configured to utilize only the media access control (MAC) address of attached network-enabled devices and apply a VLAN to the network-enabled device 104 by MAC address range.

If the current network does not support a dynamic VLAN pool system, then the provisioning system 102 may be configured to instruct the network equipment 110, from which the network-enabled device 104 is requesting access, to assign (218) the network-enabled device 104 to a “default” VLAN for the current network, and the process workflow thereafter ends (210) in the example embodiment. If, however, the current network does support a dynamic VLAN pool system, then the provisioning system 102 does not return any VLAN information to the network equipment 110, from which the network-enabled device 104 is requesting access, and defers VLAN assignment to the dynamic VLAN pool system (216), and the process workflow thereafter ends (210) in the example embodiment.

If the current network does provide support for DVCP, the provisioning system 102 may proceed to select a VLAN from a DVCP pool (220) based on a check to see if there has already been a VLAN assigned to associated network-enabled devices (222). Network-enabled devices may be associated by, but not limited to, a user, a unique device identifier, a password, an access location, or a unique user identifier. If a VLAN has previously been assigned to an associated network-enabled device, such as the network-enabled device 104, and that assignment is still active, then the provisioning system 102 may be further configured to instruct the network equipment 110, from which the network-enabled device 104 is requesting access, to assign (228) the network-enabled device 104 to the previously assigned VLAN, by returning (230) such VLAN to the network equipment 110. In addition, the provisioning system 102 may be configured to reset two timers used for maintaining health and status of assigned VLANs. The first timer may be a Zombie timer used to timeout the VLAN assignment if the provisioning system 102 has not received a refresh assignment signal for same. The second timer may be an In-Zombie timer used to remove all associations to the assigned VLAN if no refresh signals have been received. The provisioning system 102 may be further configured to instruct the network equipment 110 to apply any restrictions or policies defined for the network-enabled device 104. The process workflow thereafter ends (210) in the example embodiment.

If, however, the check at (222) determines that a VLAN has not been identified as previously assigned to an associated network-enabled device, such as the network-enabled device 104, then the provisioning system 102 may be configured to select (224) a VLAN from a database that includes a list of VLAN identifiers predefined for use as dynamically assignable. Such a list may be referred to herein as a pool of dynamically assignable VLANs, such as the pool 114. As part of selecting this VLAN, the provisioning system 102 may be configured to check to make sure this VLAN has not been assigned to other non-associated network-enabled devices and that this VLAN is not in a lockout period, also called a Zombie period.

Such lockout period may be defined in the instance that all network-enabled devices assigned to this VLAN have left the network 106 but have a high likelihood of returning in a short period of time, or within the definable Zombie period. Once a VLAN has been selected and has passed all checks, then the provisioning system 102 may be configured to instruct the network equipment 110, from which the network-enabled device 104 is requesting access, to assign (228) the network-enabled device 104 to the selected VLAN 112. In addition, the provisioning system 102 may be configured to reset the Zombie timer and the In-Zombie timer used for maintaining the health and status of assigned VLANs. As such, a DVCP VLAN has been returned (230) and the process workflow thereafter ends (210) in the example embodiment.

If, however, a check (226) determines that a dynamically assignable VLAN is not available, for at least one reason, the provisioning system 102 may be configured to check (214) to see if the current network (access venue) supports a dynamic VLAN pool system, as disclosed above. If the current network does not support a dynamic VLAN pool system, then the provisioning system 102 may be configured to instruct the network equipment 110, from which the network-enabled device 104 is requesting access, to assign the network-enabled device 104 to the default VLAN for the current network 106, thereby returning the default VLAN (218) as disclosed above. If, however, the current network 106 does support a dynamic VLAN pool system, then the provisioning system 102 does not return any VLAN information to the network equipment 110, from which the network-enabled device 104 is requesting access, and defers VLAN assignment to the dynamic VLAN pool system (216) as disclosed above, and the process workflow thereafter ends (210) in the example embodiment.

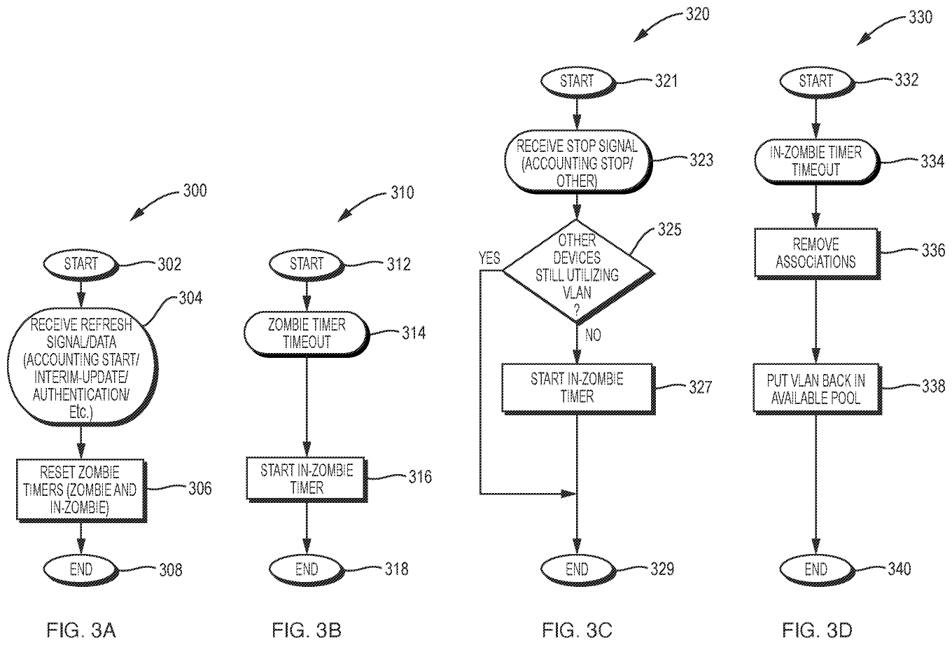

As disclosed above, the provisioning system 102 may be configured to employ a set of maintenance routines (methods) to determine if a dynamically assignable VLAN is currently in use and not available to assign to the authenticated network-enabled device 104. Such maintenance is disclosed below with regard to FIGS. 3A-D.

FIGS. 3A-D are flow diagrams of example embodiments of methods for DVCP maintenance, as disclosed below.

### Dynamic VLAN Configuration Process Maintenance

### Receive Refresh Signal

FIG. 3A is a flow diagram of an example embodiment of a method 300 for DVCP maintenance. The method 300 may begin (302) and comprise receiving periodic refresh signals (304). For example, with reference to FIG. 1 and FIG. 3A, the provisioning system 102 may be configured to receive periodic refresh signals (not shown). These signals may come from, but not be limited to, RADIUS accounting start packets, RADIUS accounting Interim-Update packets, associated network-enabled device VLAN assignment, or active VLAN monitoring. The method 300 may further comprise resetting zombie timers (306) and the method may thereafter end (308) in the example embodiment. For example, in response to receiving a refresh signal, the provisioning system 102 may be configured to reset the Zombie timer and the In-Zombie timer, disclosed above.

### Zombie Timer Timeout

When the Zombie timer reaches its definable max time, it is considered in Timeout. The Zombie timer could timeout because there have been no refresh signals received by the system before the Zombie timer reaches its maximum allowable time. When the Zombie timer times out, the provisioning system 102 may be configured to reset and start the In-Zombie timer, as disclosed below with regard to FIG. 3B.

FIG. 3B is a flow diagram of an example embodiment of another method 310 for DVCP maintenance. The method begins (312) and comprises detecting a Zombie Timer timeout (314). The method comprises starting an In-Zombie timer (316) in response to the detecting and the method thereafter ends (318) in the example embodiment.

### Receive Stop Signal

With reference back to FIG. 1, the provisioning system 102 may be configured to receive stop signals. These signals may come from, but not be limited to, RADIUS accounting stop packets, network equipment disconnect messages, or active VLAN monitoring. When a stop signal is received by the provisioning system 102, the provisioning system 102 may be configured to check to see if there are still active devices utilizing the VLAN; this could be an accounting true up of the number of devices that have been issued this VLAN and the number of stop signals received for the VLAN. If there are no other devices utilizing the VLAN, the provisioning system 102 may be configured to reset and start the In-Zombie timer, as disclosed below with regard to FIG. 3C.

FIG. 3C is a flow diagram of an example embodiment of another method 320 for DVCP maintenance. The method begins (321) and comprises receiving a stop signal (323). The stop signal may be associated with a VLAN. The method further comprises checking to see if there are still active devices utilizing the VLAN (325). If yes, the method thereafter ends (329) in the example embodiment. If, however, no active devices are utilizing the VLAN, the method may comprise starting the In-Zombie timer (327) and the method thereafter ends (329) in the example embodiment.

### In-Zombie Timer Timeout

With reference to FIG. 1, when the In-Zombie timer reaches its definable max time, it is considered in Timeout. The In-Zombie timer could timeout because there have been no refresh signals received by the provisioning system 102 before the In-Zombie timer reaches its maximum allowable time. When the In-Zombie timer times out, the provisioning system may be configured to remove all associations from the assigned VLAN. The provisioning system 102 may be configured to, in turn, put the assigned VLAN back into the available pool, that is, the pool 114 of dynamically assignable VLANs, as unused, as disclosed below with regard to FIG. 3D.

FIG. 3D is a flow diagram of an example embodiment of another method 330 for DVCP maintenance. The method begins (332) and comprises detecting an In-Zombie timer timeout (334). The method further comprises removing associations of network-enabled devices from the assigned VLAN that is associated with the In-Zombie timer (336). The method further comprises putting the assigned VLAN back into the pool of dynamically assignable VLANs (338) and the method thereafter ends (340) in the example embodiment.

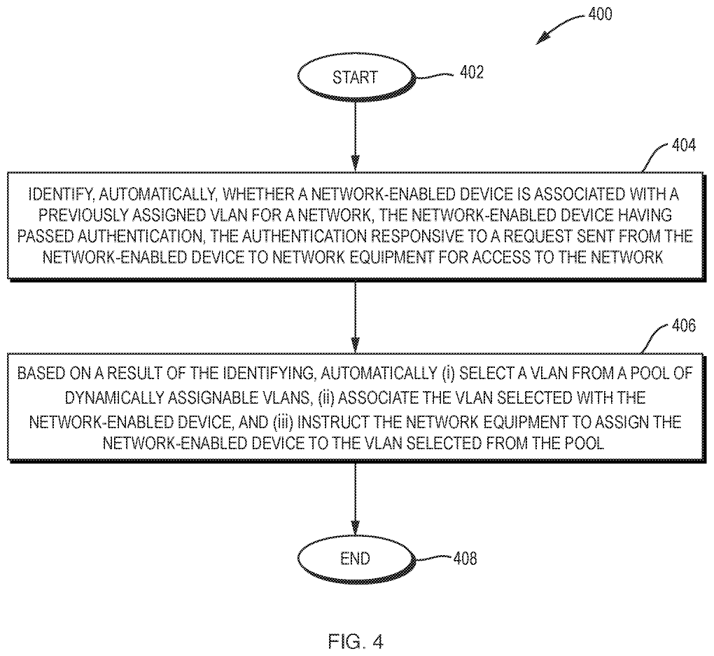

The methods 300, 310, 320, and 330 for DVCP maintenance, disclosed above with regard to FIGS. 3A, 3B, 3C, and 3D, respectively, may be employed in a computer-implemented method for VLAN assignment, such as the method of FIG. 4, disclosed below.

FIG. 4 is a flow diagram of an example embodiment of a computer-implemented method 400 for dynamic VLAN assignment. The method begins (402) and comprises identifying, automatically, whether a network-enabled device is associated with a previously assigned VLAN for a network (404). The network-enabled device has passed authentication. The authentication is responsive to a request sent from the network-enabled device to network equipment for access to the network. The computer-implemented method further comprises, based on a result of the identifying, automatically (i) selecting a VLAN from a pool of dynamically assignable VLANs, (ii) associating the VLAN selected with the network-enabled device, and (iii) instructing the network equipment to assign the network-enabled device to the VLAN selected from the pool (406). The method thereafter ends (408) in the example embodiment.

FIG. 5 is a block diagram of an example of the internal structure of a computer 550 in which various embodiments of the present disclosure may be implemented. The computer 550 contains a system bus 552, where a bus is a set of hardware lines used for data transfer among the components of a computer or digital processing system. The system bus 552 is essentially a shared conduit that connects different elements of a computer system (e.g., processor, disk storage, memory, input/output ports, network ports, etc.) that enables the transfer of information between the elements. Coupled to the system bus 552 is an I/O device interface 554 for connecting various input and output devices (e.g., keyboard, mouse, displays, printers, speakers, etc.) to the computer 550. A network interface 556 allows the computer 550 to connect to various other devices attached to a network (e.g., global computer network, wide area network, local area network, etc.). Memory 558 provides volatile or non-volatile storage for computer software instructions 560 and data 562 that may be used to implement embodiments (e.g., methods 200, 300, 310, 320, 330, and 400) of the present disclosure, where the volatile and non-volatile memories are examples of non-transitory media. Disk storage 564 provides non-volatile storage for computer software instructions 560 and data 562 that may be used to implement embodiments (e.g., methods 200, 300, 310, 320, 330, and 400) of the present disclosure. A central processor unit 566 is also coupled to the system bus 552 and provides for the execution of computer instructions.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods described herein. It should be understood that elements of the block and flow diagrams may be implemented in software or hardware, such as via one or more arrangements of circuitry of FIG. 5, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method for dynamic virtual local area network (VLAN) assignment, the computer-implemented method comprising:
identifying, automatically, whether a network-enabled device is associated with a previously assigned VLAN for a network, the network-enabled device having passed authentication, the authentication responsive to a request sent from the network-enabled device to network equipment for access to the network; and
based on a result of the identifying, automatically (i) selecting a VLAN from a pool of dynamically assignable VLANs, (ii) associating the VLAN selected with the network-enabled device, and (iii) instructing the network equipment to assign the network-enabled device to the VLAN selected from the pool.

2. The computer-implemented method of claim 1, wherein (i), (ii), and (iii) are performed, automatically, based on the result indicating that there is no previously assigned VLAN associated with the network-enabled device and wherein, in an event the result indicates that the network-enabled device is associated with the previously assigned VLAN, the computer-implemented method further comprises instructing the network equipment to assign the network-enabled device to the previously assigned VLAN.

3. The computer-implemented method of claim 1, wherein (i), (ii), and (iii) are performed, automatically, based on the result indicating that a) there is no previously assigned VLAN associated with the network-enabled device and b) the network-enabled device is not associated with another network-enabled device that has received a respective VLAN assignment.

4. The computer-implemented method of claim 1, wherein, in an event the result indicates that there is no previously assigned VLAN associated with the network-enabled device and that the network-enabled device is associated with a different network-enabled device that is associated with a respective VLAN from the pool, the computer implemented method does not perform (i), (ii), and (iii) and comprises:
associating the network-enabled device with the respective VLAN associated with the different network-enabled device; and
instructing the network equipment to assign the network-enabled device to the respective VLAN.

5. The computer-implemented method of claim 1, wherein the pool of dynamically assignable VLANs is stored in a database and wherein the identifying includes retrieving data from the database and identifying whether the network-enabled device is associated with the previously assigned VLAN based on the data retrieved.

6. The computer-implemented method of claim 1, further comprising:
maintaining the pool of dynamically assignable VLANs based on at least one timer;
refreshing a timer of the at least one timer based on receipt of a refresh signal, the timer associated with the VLAN selected;
in response to a timeout of the timer, dissociating the VLAN selected from the network-enabled device and all other network-enabled devices associated with the VLAN selected, the dissociating causing the VLAN selected to be returned to the pool as an unused VLAN, the timeout due to lack of receipt of the refresh signal; and
in response to the dissociating, instructing the network equipment to de-assign the network-enabled device from the VLAN selected.

7. The computer-implemented method of claim 1, wherein the selecting includes ensuring that the VLAN selected from the pool of dynamically assignable VLANs is not associated with another network-device that is not associated with the network device and ensuring that the VLAN selected is not in a lockout period.

8. The computer-implemented method of claim 1, further comprising associating the VLAN selected with the network-enabled device and a credential of a user of the network-enabled device.

9. The computer-implemented method of claim 1, further comprising associating the VLAN selected with a media access control (MAC) address of the network-enabled device, embedded identity document (EID) corresponding to an embedded subscriber identity module (eSIM) of the network-enabled device, or other unique identifier of the network-enabled device.

10. A system for virtual local area network (VLAN) assignment, the system comprising:
at least one processor; and
at least one memory, the at least one memory having encoded thereon a sequence of instructions which, when loaded and executed by the at least one processor, causes the at least one processor to:
identify, automatically, whether a network-enabled device is associated with a previously assigned VLAN for a network, the network-enabled device having passed authentication, the authentication responsive to a request sent from the network-enabled device to network equipment for access to the network; and
based on a result of the identifying, automatically (i) select a VLAN from a pool of dynamically assignable VLANs, (ii) associate the VLAN selected with the network-enabled device, and (iii) instruct the network equipment to assign the network-enabled device to the VLAN selected from the pool.

11. The system of claim 10, wherein the system is a cloud-based system.

12. The system of claim 10, wherein the sequence of instructions further causes the at least one processor to perform (i), (ii), and (iii), automatically, based on the result indicating that there is no previously assigned VLAN associated with the network-enabled device and wherein, in an event the result indicates that the network-enabled device is associated with the previously assigned VLAN, the sequence of instructions further causes the at least one processor to instruct the network equipment to assign the network-enabled device to the previously assigned VLAN.

13. The system of claim 10, wherein the sequence of instructions further causes the at least one processor to perform (i), (ii), and (iii), automatically, based on the result indicating that a) there is no previously assigned VLAN associated with the network-enabled device and b) the network-enabled device is not associated with another network-enabled device that has received a respective VLAN assignment.

14. The system of claim 10, wherein, in an event the result indicates that there is no previously assigned VLAN associated with the network-enabled device and that the network-enabled device is associated with a different network-enabled device that is associated with a respective VLAN from the pool, and wherein the sequence of instructions further causes the at least one processor not to perform (i), (ii), and (iii), and to:
associate the network-enabled device with the respective VLAN associated with the different network-enabled device; and
instruct the network equipment to assign the network-enabled device to the respective VLAN.

15. The system of claim 10, wherein the pool of dynamically assignable VLANs is stored in a database coupled to the system and wherein the sequence of instructions further causes the at least one processor to retrieve data from the database and identify whether the network-enabled device is associated with the previously assigned VLAN based on the data retrieved.

16. The system of claim 10, wherein the sequence of instructions further causes the at least one processor to:
maintain the pool of dynamically assignable VLANs based on at least one timer;
refresh a timer of the at least one timer based on receipt of a refresh signal, the timer associated with the VLAN selected;
in response to a timeout of the timer, dissociate the VLAN selected from the network-enabled device and all other network-enabled devices associated with the VLAN selected, the dissociating causing the VLAN selected to be returned to the pool as an unused VLAN, the timeout due to lack of receipt of the refresh signal; and
in response to the dissociating, instruct the network equipment to de-assign the network-enabled device from the VLAN selected.

17. The system of claim 10, wherein the sequence of instructions further causes the at least one processor to ensure that the VLAN selected from the pool of dynamically assignable VLANs is not associated with another network-device that is not associated with the network device and ensure that the VLAN selected is not in a lockout period.

18. The system of claim 10, wherein the sequence of instructions further causes the at least one processor to associate the VLAN selected with the network-enabled device and a credential of a user of the network-enabled device.

19. The system of claim 10, wherein the sequence of instructions further causes the at least one processor to associate the VLAN selected with a media access control (MAC) address of the network-enabled device, embedded identity document (EID) corresponding to an embedded subscriber identity module (eSIM) of the network-enabled device, or other unique identifier of the network-enabled device.

20. A non-transitory computer-readable medium for virtual local area network (VLAN) assignment, the non-transitory computer-readable medium having encoded thereon a sequence of instructions which, when loaded and executed by at least one processor, causes the at least one processor to:
identify, automatically, whether a network-enabled device is associated with a previously assigned VLAN for a network, the network-enabled device having passed authentication, the authentication responsive to a request sent from the network-enabled device to network equipment for access to the network; and
based on a result of the identifying, automatically (i) select a VLAN from a pool of dynamically assignable VLANs, (ii) associate the VLAN selected with the network-enabled device, and (iii) instruct the network equipment to assign the network-enabled device to the VLAN selected from the pool.
